(19) United States
(12) Patent Application Publication
(10) Pub. No.: US 2009/0045275 A1
(43) Pub. Date: Feb. 19, 2009

(54) Waste Chopper Kit

(76) Inventor: Beverly Ann Lambert, Marlborough, MA (US)

Correspondence Address: NW-IP-LAW, 6039 E. Grant RD., Tucson, AZ, 85712, US

(21) Appl. No.: 11/838,627

(22) Filed: Aug. 14, 2007

(51) Int. Cl. B26B 27/00; E03D 9/10

(52) U.S. Cl. 241/169.2; 4/255.01

(57) ABSTRACT

The present invention provides a waste chopper kit that can be used to prevent toilet clogging.

### FIELD OF THE INVENTION

The present invention is directed to a novel waste chopper kit.

### BACKGROUND OF THE INVENTION

A conventional toilet would not properly flush if the waste (e.g., stool) is too bulky. That is, bulky waste can clog the toilet and cause messy overflow. Therefore, there is a need for a kit to facilitate the flushing of bulky waste down the toilet.

### SUMMARY OF THE INVENTION

The present invention provides a waste chopper kit 10 that can be used to prevent toilet clogging. In some embodiments, the present invention features a waste chopper kit 10 comprising a chopper 90 having a flat blade 20 vertically mounted to a distal end of a shaft 30, and a container 80 having an orifice 100. The maximum radius of the flat blade 20 is smaller than a minimum radius of the orifice 100 of the container 80 such that the flat blade 20 can be inserted through the orifice for storage within the container. In some embodiments, the shaft 30 of the chopper 90 may comprise a shield 50 forming around the shaft 30. In some embodiments, the shaft 30 of the chopper 90 may comprise an accessory chamber 60. In some embodiments, a deodorizer can be placed into the chamber 60. In some embodiments, the blade that is vertically mounted to the distal end of the shaft 30 is a three-edge blade 22, instead of a flat blade 20.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 shows a perspective view of a chopper kit 10.

FIG. 2 shows the chopper 90 outside of the container 80.

FIG. 3 shows an accessory chamber 60 located on the shaft 30.

FIG. 4 shows a three-edge blade vertically mounted at a distal end of a shaft 30.

### DESCRIPTION OF PREFERRED EMBODIMENTS

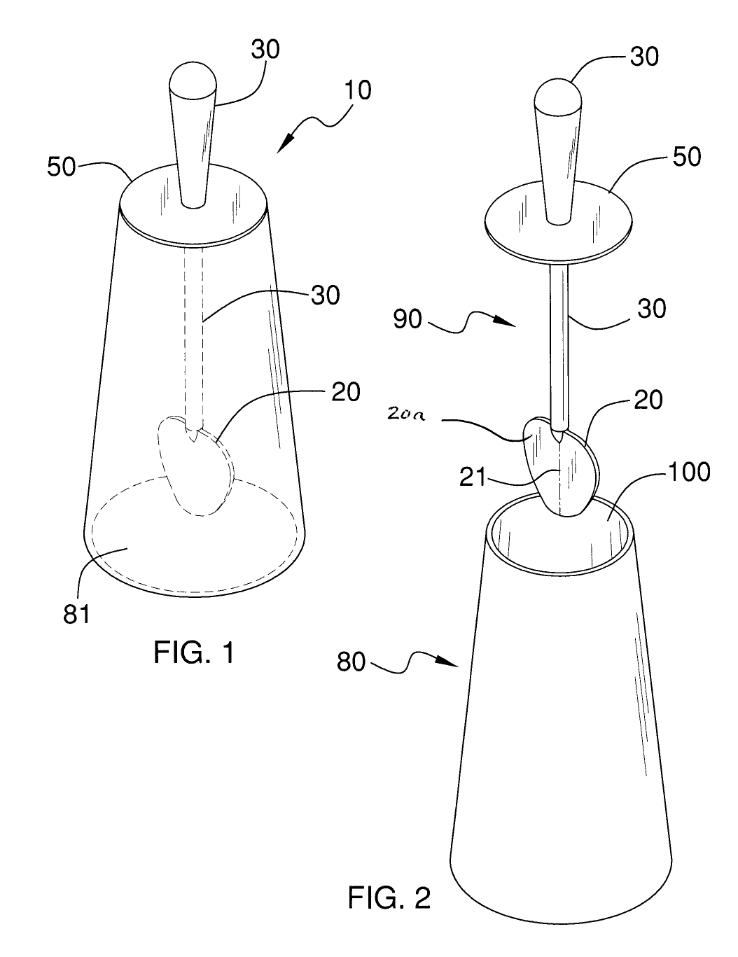

In some embodiments, the present invention features a waste chopper kit 10 comprising a chopper 90 having a flat blade 20 vertically mounted to a distal end of a shaft 30, and a container 80 having an orifice 100. See FIG. 1. To prevent toilet clogging, prior to flushing the waste the operator can chop of the waste (e.g., stool) into smaller pieces to facilitate the flushing. To chop the waste into smaller pieces, the operator can slice the waste with the blade 20.

The maximum radius of the flat blade 20 is smaller than a minimum radius of the orifice 100 of the container 80 such that the flat blade 20 can be inserted through the orifice for storage within the container. See FIG. 2. The maximum radius of the flat blade 20 is the distance from the midline 21 of the blade 20 to farthest outer edge of the flat blade (e.g. the broadest section of the flat blade 20). See FIG. 2. In some embodiment, the flat blade 20 is symmetrical with respect to the midline of the flat blade 20.

In some embodiments, the shaft 30 of the chopper 90 may comprise a shield 50 forming around the shaft 30. See FIG. 2. In some embodiments, the shield 50 can be the same shape as that of the orifice 100.

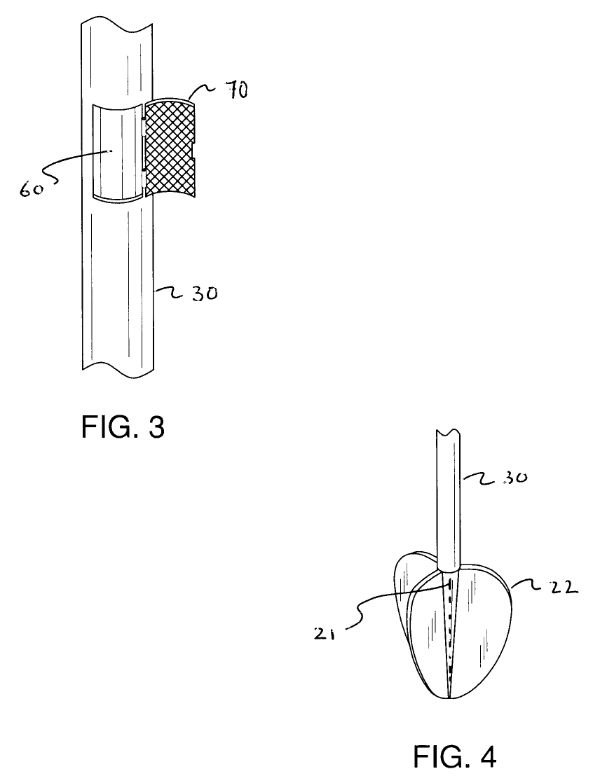

In some embodiments, the shaft 30 of the chopper 90 may comprise an accessory chamber 30. See FIG. 3. To improve the smell of the toilet environment, a deodorizer can be placed into the accessory chamber. In some embodiments, the deodorizer stored in the accessory chamber 30 can be secured therein by a screen door 70.

In some embodiments, the blade that is vertically mounted to the distal end of the shaft 30 is a three-edge blade 22, instead of a flat blade 20. See FIG. 4. The maximum radius of three-edge blade 20 is smaller than a minimum radius of the orifice 100 of the container 80 such that the three-edge blade 20 can be inserted through the orifice for storage within the container. The maximum radius of the flat blade 20 is the distance from the midline 21 of the blade 20 to farthest outer edge of the flat blade (e.g. the broadest section of the flat blade 20). See FIG. 2. In some embodiment, the flat blade 20 is symmetrical with respect to the midline of the flat blade 20.

In some embodiments, the shaft 30 is 6-16 inches, the blade 20 or 22 is about 2-5 inches long and about 1-3 inches broad (e.g., radius 0.5-1.5 inches), the shield is located about 3-6 inches from the proximal end of the shaft 30 (proximal end is the end of the shaft that is farthest away from the blade, not the end where the blade is mounted to). In some embodiments, the container may be a cylindrical shape with a bottom cover 81 (see FIG. 1). The height of the container 80 may be about 8-13 inches, and the orifice may be about 2-5 inches.

In some embodiments, the shaft 30 has a circular cross section, e.g. with a diameter of about 0.5 inch to about 1 inch. As used herein, the term “about” means a plus or minus of 10%. In some embodiments, the shaft 30 has a square cross section, e.g., having a cross section area of about 0.25 inch square to about 1 inch square. In some embodiments, the shaft 30 has a triangular cross section, e.g., having a cross section area of about 0.25 inch square to about 1 inch square.

In some embodiments, the blade 20 is has a symmetrical shape with respect to the midline 21. In some embodiments, the blade 20 is of any geometric shape and size such that the blade 20 can be moved about freely in the reservoir space at the bottom of a conventional toilet bowl where stool settles before it gets flushed, wherein the blade is effective to chop up the stool into smaller fragments to prevent clogging when the stool is flushed (e.g., for ease of flushing). A conventional reservoir space at the bottom of a toilet bowl has an opening with a radius of about 1 to 2 inches. In some embodiments, the blade 20 is of any symmetrical geometric shape and size such that the blade 20 can be moved about freely in the reservoir space at the bottom of a conventional toilet bowl where stool settles before it gets flushed, wherein the blade is effective to chop up the stool. In some embodiments, the portion of the blade 20 being attached to the shaft 30 (i.e., the top portion of the blade 20) has a larger radius (measured from the midline) than the lower portion of the blade 20. In some embodiments, the tip of the lower portion of the blade is rounded, so that it can effectively chop up stool lying at the bottom of the reservoir space at the bottom of a conventional toilet bowl. As used herein, a “rounded” blade has no vertex, or sharp edge, as viewed from the front side 20a or backside of the blade 20 (the front side 20a and backside of the blade are the flat sides shown in FIG. 2). In some embodiments, the blade has an edge thickness of about 1/32 of an inch to about ¼ of an inch. In some embodiments, the blade 20 has an equal thickness throughout. In some embodiments, the midline 21 of the blade 20 has a thickness that is about 10% to about 25% thicker than the outer edge of the blade.

In some embodiments, the blade 20 has a “heart-shape” configuration, with a rounded tip. In some embodiments, the blade 20 has a square shape configuration (e.g., about 2 inches×2 inches). In some embodiments, the blade 20 has a rectangle configuration (e.g., about 2 inches×1.5-4 inches). In some embodiments, the blade 20 has a triagular configuration, with one or more rounded tip. In some embodiments, the shaft 30 connects to a midline of any of the above configuration (the midline is defined as an imaginary line that would symmetrically divide the blade). In some embodiments, the front side (or backside) of the blade has a surface area of about 1 inch square to about 4 inch square, e.g., about 1 inch square, about 2 inch square, about 3 inch square, about 4 inch square, etc.

In some embodiments, the chopper kit is constructed from a plastic, e.g., polymeric material such as acrylonitrile, styrene, acrylic, and mixtures thereof. See, for example, U.S. Pat. No. 6,451,882, the disclosure of which is incorporated in its entirety herein by reference. In some embodiment, the chopper kit is constructed from a metal, e.g., aluminium, copper, metal alloys, etc. In some embodiments, the chopper kit is constructed from a mixture of a plastic and a metal, e.g., the container being metal and the blade being plastic. In some embodiments, one or more components, e.g., the chopper, the blade, of the chopper kit is constructed from a plastic. In some embodiments, one or more components of the chopper kit is constructed from ceramic.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A waste chopper kit comprising:
(a) a chopper having a flat blade vertically mounted to a distal end of a shaft, wherein the blade has a symmetrical geometric shape with respect to the midline of the blade, and the blade can be moved about freely in a reservoir space at the bottom of a conventional toilet bowl where a stool settles before it gets flushed, wherein the blade is effective to chop up the stool into smaller fragments for ease of flushing; and
(b) a container having an orifice, a maximum radius of the flat blade is smaller than a minimum radius of the orifice of the container such that the flat blade can be inserted through the orifice for storage within the container.

2. The chopper kit of claim 1 further comprising a shield forming around the shaft.

3. The chopper kit of claim 1 wherein the shaft further comprises an accessory chamber.
